(19) United States
(12) Patent Application Publication
(10) Pub. No.: US 2009/0317643 A1
(43) Pub. Date: Dec. 24, 2009

(54) COMPOSITE PRODUCT AND METHOD OF MANUFACTURING THE SAME

(76) Inventor: Chih-Lin Hsu, Taipei City (TW)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/480,839

(22) Filed: Jun. 9, 2009

(30) Foreign Application Priority Data
Jun. 18, 2008 (TW) 097122675

(51) Int. Cl. B32B 15/08

(52) U.S. Cl. 428/457

(57) ABSTRACT

A method of manufacturing a composite product includes the following steps of preparing at least one metallic piece; placing the metallic piece into a mold and then punching the metallic piece to be bent after the mold is closed; and injecting a polymer into the mold to allow the polymer contact the surface of the metallic piece. The metallic piece can be a single-layered metallic plate or a composite metallic plate. With the implementation of the invention, the production cost can be saved and the production procedure can be simplified. A composite product is further provided.

### CROSS-REFERENCE TO RELATED APPLICATION

This application claims priority under 35 U.S.C. § 119 to Taiwan Patent Application No. 097122675, filed on Jun. 18, 2008, in the Taiwan Intellectual Property Office, the entire contents of which are hereby incorporated by reference.

### BACKGROUND OF THE INVENTION

1. Field of the Invention

The present invention relates to a composite product, and especially to a composite product and a method of manufacturing the same.

2. Description of Related Art

Metals have significant structural strength compared to plastics. In contrast plastics are cheaper than metals and have superior plasticity instead. In order to balance between the structural strength, aesthetics and production cost, many electronic appliances have casings made of composite material including metals and plastics. The metals and plastics are bonded to each other by adhesives or mechanic means such as hooks, screws or tacks.

However, whichever way is chosen, bonding the metals to the plastics needs complicate procedures, adversely affecting mass production and thus commercial competitiveness.

Therefore, there is a need of an invention that overcomes the above disadvantages.

### SUMMARY OF THE INVENTION

It is one object of the present invention to provide a composite product with reduced production cost and a manufacturing method with simplified product procedure, contributing to faster production rate and therefore ease to mass production.

In order to achieve the above and other objectives, the method of manufacturing a composite product includes the following steps: preparing at least one metallic piece; placing the metallic piece into a mold, wherein the metallic piece is punched to be bent after the mold is closed; and injecting a polymer into the mold to allow the polymer contact the surface of the metallic piece.

According to another aspect of the invention, a composite product is further provided. The composite product includes at least one metallic piece; at least an adhesive layer, attached on one surface of the metallic piece; and an injected polymer, wherein the adhesive layer connects the metallic piece to the injected polymer.

The invention offers the following advantages. The number of parts needed is reduced. Production procedures such as cutting, trimming, polishing and assembling are simplified. Because injection molding is used in the invention to bond the metallic plates/parts to the polymer, the composite products obtained have minimized dimensions. Furthermore, the storage space, management and transport cost for a great number of parts can be significantly reduced. The time for preparing the production stock can be also saved, which increase the production rate and contributes to mass production.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a flow chart of a method of manufacturing a composite product according to the invention.

FIG. 2 is a perspective view of a composite metallic plate according to a first embodiment of the invention.

FIG. 3 is an enlarged view of part A in FIG. 2.

FIG. 4 is a perspective view of a composite metallic plate according to a second embodiment of the invention.

FIG. 5 is a perspective view of a composite metallic plate according to a third embodiment of the invention.

FIG. 6 is a perspective view of a composite product according to the first embodiment of the invention.

FIG. 7 is a cross-sectional view taken along the line 7-7 of FIG. 6.

FIG. 8 is a perspective view of a composite product according to the second embodiment of the invention.

FIG. 9 is a cross-sectional view taken along the line 9-9 of FIG. 8.

FIG. 10 is a perspective view of a composite product according to the third embodiment of the invention.

FIG. 11 is a cross-sectional view taken along the line 11-11 of FIG. 10.

### DETAILED DESCRIPTION OF THE PREFERRED EMBODIMENTS

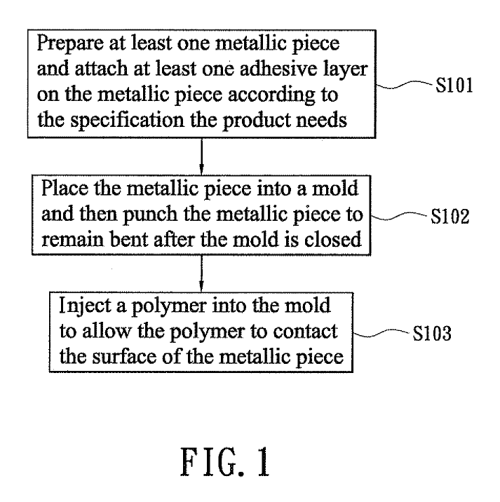

Referring to FIG. 1, a method of manufacturing a composite product according to the present invention includes the following steps:

S101: At least one metallic piece is prepared. The metallic piece can be a single-layered metallic plate or a composite metallic plate. On one surface of the metallic piece is attached at least an adhesive layer. The adhesive layer can be an adhesive film or adhesive glue.

S102: A mold is provided according to specification the product needs. The metallic piece is placed into the mold and then punched to remain bent after the mold is closed.

S103: A polymer is injected into the mold to allow the polymer contact the surface of the metallic piece. The polymer can be hard plastic or flexible plastic. The adhesive layer enhances the bonding strength between the metallic piece and the polymer.

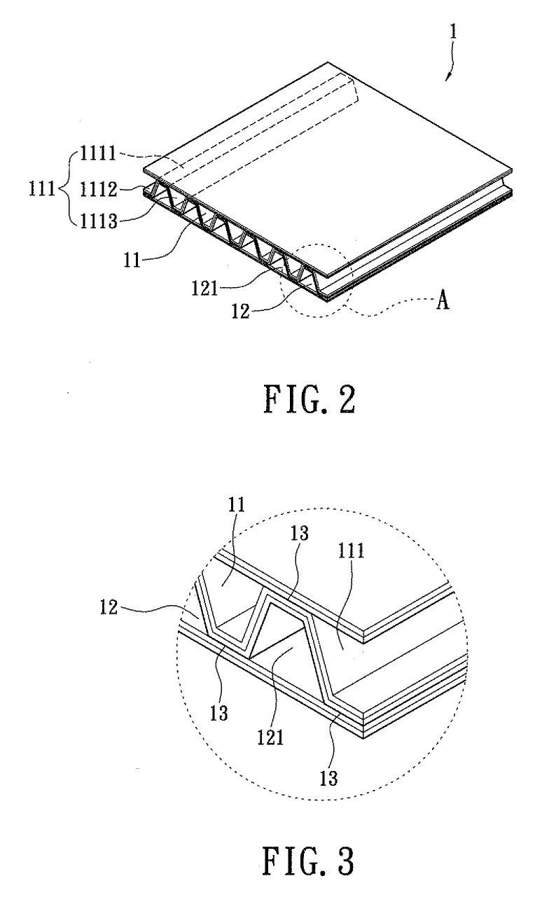

Referring to FIG. 2 through FIG. 5, in the case that a metallic piece 1 is a composite metallic plate, the composite metallic plate can be implemented in various embodiments. Three embodiments are illustrated here below without any limit to the scope of the invention. As shown in FIG. 2 and FIG. 3, the metallic piece 1 has one bent first metallic plate 11, two flat second metallic plates 12 and a plurality of bonding layers 13. The first metallic plate 11 has a plurality of bent first metallic parts 111. Each of the second metallic plates 12 has a plurality of flat second metallic parts 121. Some of the bonding layers 13 connect the first metallic plate 11 to the second metallic plates 12, while others connect the first metallic parts 111 to the second metallic parts 121 into layers. All of the first metallic parts 111 have a plurality of first bases 1111, a plurality of second bases 1112 and a plurality of sides 1113. The sides 1113 respectively connect the first bases 1111 to the second sides 1112 which locate at different level of height. The first bases 1111 connects the second metallic parts 121 of the second metallic plate 12 in a manner that the first metallic plate 11 contacts two neighboring second metallic plates 12.

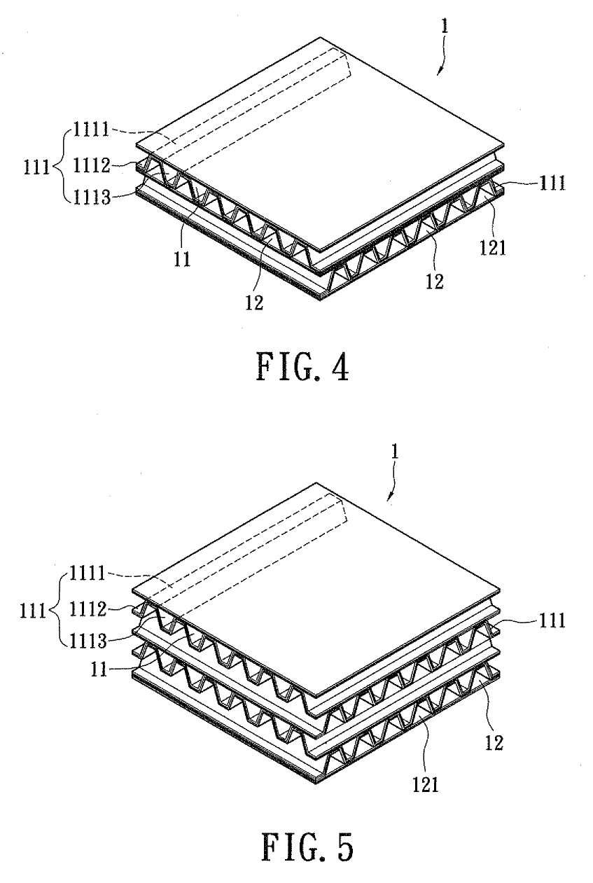

As shown in FIG. 4, which is a second embodiment of the invention, the structure of the composite product is the same as that shown in FIGS. 2 and 3, except that the metallic piece 1 has a plurality of alternately arranged bent first metallic plates 11 and flat second metallic plates 12. The first bases 1111 and the second bases 1112 respectively connect to the second metallic parts of the second metallic plates 12.

As shown in FIG. 5, which is a third embodiment of the invention, the structure of the composite product is the same as that shown in FIGS. 2 and 3, except that the metallic piece has a plurality of bent first metallic 11 and two flat second metallic plates 12. The first metallic plate 11 contacts two neighboring second metallic plates 12. A first base 1111 of one first metallic plate 11 connects to a second metallic part 121 of one of the two neighboring second metallic plates 12, while a second base 1112 of the other first metallic plate 11 connects to a second metallic part 121 of the other of the neighboring second metallic plates 12. A first base 1111 and a second base 1112 of each of other first metallic plates 11 respectively connect to a second base 1112 and a first base 1111 of the corresponding first metallic plate 11.

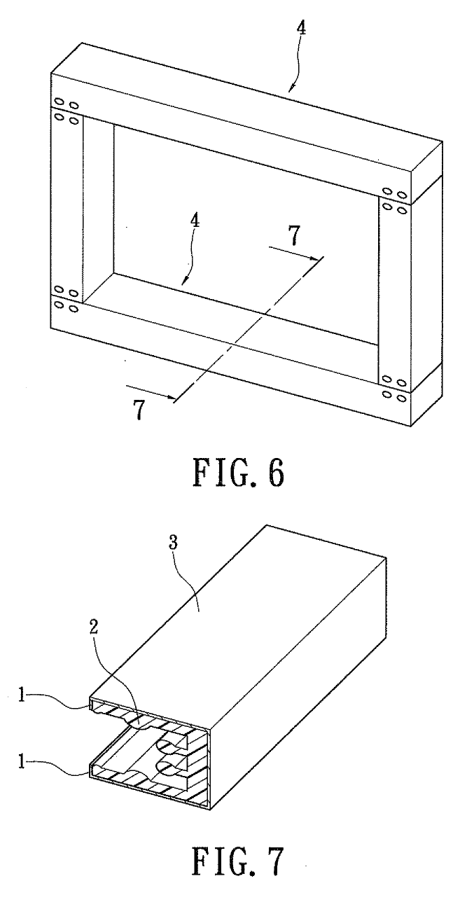

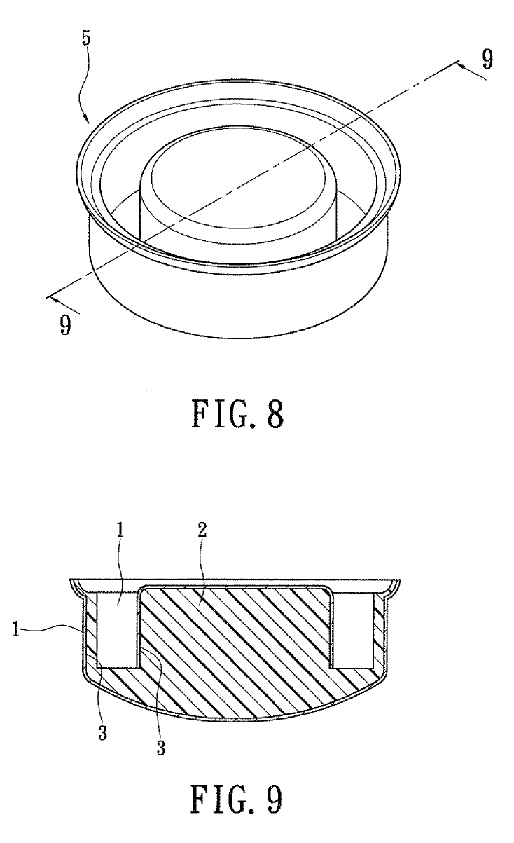

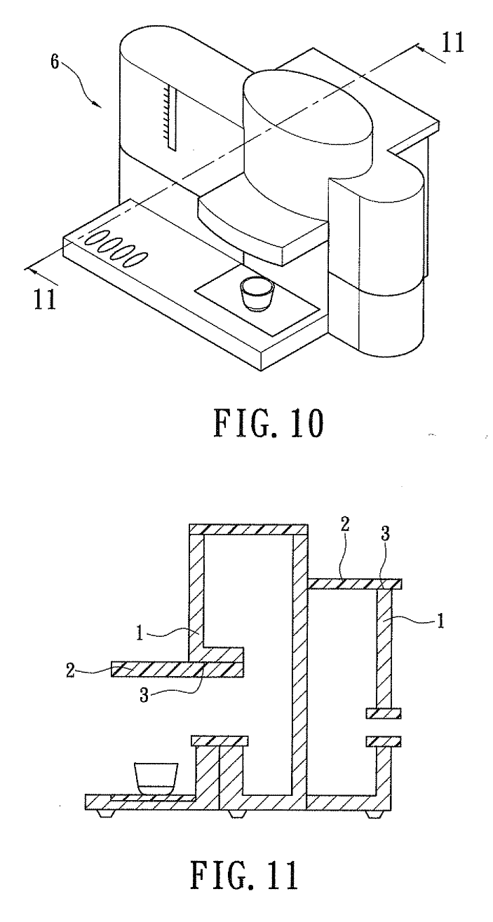

The invention further provides a composite product including a metallic piece 1, an injected polymer 2 and an adhesive layer 3. The metallic piece 1 can be a single-layered metallic plate or a composite metallic plate. The adhesive layer 3 can be an adhesive film or adhesive glue. The adhesive layer adheres to the surface of the metallic piece 1 and connects the metallic piece 1 to the polymer 2. FIG. 6 through FIG. 11 show embodiments of a composite product having three parts such as frame 4, column-shaped lid 5 and a coffee machine 6.

The composite product and the method of manufacturing the composite product according to the invention provide a new design aspect. In the case that the metallic piece 1 is a composite metallic plate which includes an expensive metal and an inexpensive metal, it is economic in material cost with remarkable strength compared to a purely metallic plate. The amount of material or the number of different kinds of material needed for the composite product are significantly reduced. Furthermore, the processing procedures such as cutting, trimming, polishing or assembling can be simplified. The metal and the polymer are bonded to each other by injection molding, which can achieve smaller sizes compared to the prior art. Therefore, the storage space, management and transport for huge amount of components or parts needed to finish the composite product can be saved. The time needed to prepare the production materials is shortened so that production yield can increase, contributing to the mass production.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method of manufacturing a composite product, comprising
preparing at least one metallic piece;
placing the metallic piece into a mold, wherein the metallic piece is punched to remain bent after the mold is closed; and
injecting a polymer into the mold to allow the polymer contact the surface of the metallic piece.

2. The method of claim 1, wherein the metallic piece is a composite metallic plate having a plurality of metallic plates and bonding layers, each of the metallic plates having a plurality of metallic parts, some of the bonding layers connecting the metallic plates while others bond the metallic parts into layers.

3. The method of claim 2, wherein the metallic piece has at least one bent first metallic plate and at least two flat second metallic plates, the first metallic plate is formed by a plurality of bent first metallic parts, the second metallic plates are formed by a plurality of flat second metallic parts, each of the first metallic parts has a plurality of first bases, second bases and sides, and the sides respectively connect the first bases to the second bases.

4. The method of claim 3, wherein the first bases connect to the second metallic parts of one of two neighboring second metallic plates, while the second bases connect to the second metallic parts of the other of two neighboring second metallic plates, so that the first metallic plates connect two neighboring metallic second plates.

5. The method of claim 3, wherein the metallic piece has a plurality of alternately arranged first metallic plates and second metallic plates, and the first bases and the second bases respectively connect to the second metallic parts of the second metallic plates.

6. The method of claim 3, wherein the metallic piece has a plurality of first metallic plates and two second metallic plates, the first metallic plates connect the two second metallic plates, a first base of one of the first metallic plates connects to the second metallic part of one of the two second metallic plates while the second base of another first metallic plate connects to a second metallic part of the other one of the two second metallic plates, so that the first base and the second base of each of the remaining first metallic plates respectively connect to the second base and the first base of their neighboring first metallic plate.

7. The method of claim 1, wherein the polymer is hard plastic.

8. The method of claim 1, wherein the polymer is flexible plastic.

9. The method of claim 1, wherein at least an adhesive layer is attached on the surface of the metallic piece before the metallic piece is placed into the mold.

10. The method of claim 9, wherein the adhesive layer is an adhesive film or adhesive glue.

11. The method of claim 1, wherein the metallic piece is a single-layered metallic plate.

12. A composite product, comprising:
at least one metallic piece;
at least an adhesive layer attached on one surface of the metallic piece; and
an injected polymer, wherein the adhesive layer connects the metallic piece to the injected polymer.

13. The composite product of claim 12, wherein the metallic piece is a composite metallic plate having a plurality of metallic plates and bonding layers, each of the metallic plates having a plurality of metallic parts, some of the bonding layers connecting the metallic plates together while others bonding the metallic parts together.

14. The composite product of claim 12, wherein the metallic piece is a single-layered metallic plate.

15. The composite product of claim 12, wherein the adhesive layer is an adhesive film or adhesive glue.

16. A method of manufacturing a composite product, comprising:
preparing at least one metallic piece; and
attaching at least one adhesive layer onto one surface of the metallic piece.

17. A composite product, comprising:
at least one metallic piece; and
at least one adhesive layer attached on one surface of the metallic piece.
